(19) United States
(12) Patent Application Publication
(10) Pub. No.: US 2024/0415724 A1
(43) Pub. Date: Dec. 19, 2024

(54) FOUR-WHEEL WALKER WITH LARGE FRONT WHEEL AND SMALL REAR WHEEL

(71) Applicant: Xianhe Yang, Beijing (CN)

(72) Inventor: Xianhe Yang, Beijing (CN)

(21) Appl. No.: 18/731,230

(22) Filed: May 31, 2024

(30) Foreign Application Priority Data
May 31, 2023 (CN) 202321368922.9

(51) Int. Cl. A61H 3/04

(52) U.S. Cl. CPC A61H 3/04

(57) ABSTRACT

A four-wheel walker with two equal-sized front wheels larger than the two equal-sized rear wheels are provided. In one embodiment, the two large-sized front wheels are fixed wheels and the two small-sized rear wheels are swivel wheels. In one embodiment, the radius R1 of the two equal-sized front wheels and the radius R2 of the two equal-sized rear wheels are optimized for balance. In one embodiment, the two rear wheels are removable. In yet another embodiment, In yet another embodiment, the walker is foldable. In one embodiment, the two rear wheels are smaller than the two front wheels, and wherein the two front wheels are fix wheel, and wherein each of the two rear wheels are mounted on a corresponding castor, and where each castor is attached to the end of corresponding rear leg. In one embodiment, the castors are swivel castors.

### CROSS REFERENCE TO RELATED APPLICATION

This application claims priority under 35 U.S.C. $119 from Chinese Application Number 202321368922.9, titled “FOUR-WHEEL WALKER WITH LARGE FRONT WHEEL AND SMALL REAR WHEEL,” filed on May 31, 2023. The disclosure of each of the foregoing documents is incorporated herein by reference.

### TECHNICAL FIELD

The disclosed embodiments relate generally to assistance devices, and, more particularly, to four-wheel walkers.

### BACKGROUND

The senior population is growing worldwide. Currently, there are more than 700 million people aged 60 or over, and this number is expected to double to 1.5 billion by 2050. The elderlies are more prone to physical weakness, which can make walking difficult. To help, walkers are now available on the market. These walkers are made of light and strong aluminum alloy tubes, and are designed with comfort and stability in mind. Special attention is given to simplicity and safety, making them ideal for the elderly.

However, the problem occurs that walkers on the market these days does not adapt to different ability of the elderly people. While the walker's material and structure have been made with the elderly in mind, different elderly people have different physiques, abilities, and legs. As a result, the walker's adaptability to different people varies.

Improvements are needed to have a walker that is easily adapt to different physical ability users.

### SUMMARY

Design of four-wheel walker with different sized wheels are provided. In one novel aspect, a walker with a pair of laterally spaced and generally vertically dispensed front legs, a pair of laterally spaced rear legs, two ground engaging front wheels, each attached to the end of the two front legs respectively, two ground engaging rear wheels, each attached to the end of the two front legs respectively, wherein the two front wheels having an equal size with a radius of R1, and the two rear wheels having an equal size with a radius of R2; and wherein R1 and R2 are not equal. In one embodiment, R1 is greater than R2. In another embodiment, R1 is at least three times bigger than R2. In yet another embodiment, the two front wheels are fixed wheels that cannot rotate, and the two rear wheels are swivel wheels.

In one embodiment, the two front wheels are fixed wheels that cannot rotate with R1, and the two rear wheels are swivel wheels with R2, and wherein R1 is at least three time bigger than R2.

In one embodiment, the two rear wheels are removable. In yet another embodiment, In yet another embodiment, the walker is foldable. In one embodiment, the two rear wheels are smaller than the two front wheels, and wherein the two front wheels are fix wheel, and wherein each of the two rear wheels are mounted on a corresponding castor, and where each castor is attached to the end of corresponding rear leg. In one embodiment, the castors are swivel castors.

### BRIEF DESCRIPTION OF THE DRAWINGS

The accompanying drawings, where like numerals indicate like components, illustrate embodiments of the invention.

FIG. 1 illustrates an exemplary diagram of a four-wheel walker with large front wheels and small rear wheels in accordance with embodiments of the current invention.

FIG. 2 illustrates an exemplary diagram of a swivel wheel for the rear wheel in accordance with embodiments of the current invention.

### DETAILED DESCRIPTION

Reference will now be made in detail to some embodiments of the invention, examples of which are illustrated in the accompanying drawings.

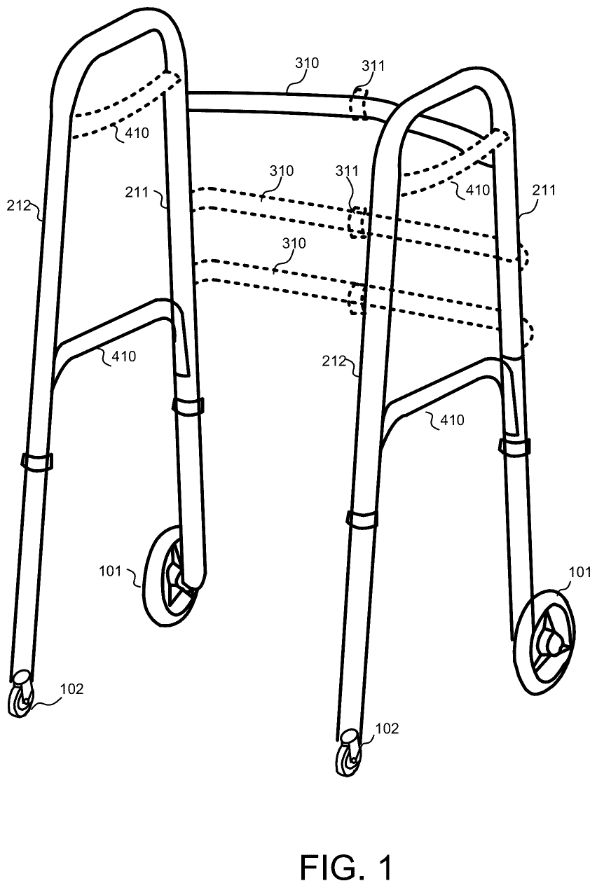

FIG. 1 illustrates an exemplary diagram of a four-wheel walker with large front wheels and small rear wheels in accordance with embodiments of the current invention. In order to help the elderly to walk, walkers have been produced on the market. The materials of the walkers are light and strong aluminum alloy tubes. In terms of design, according to the characteristics of the elderly, special attention is paid to simplicity and comfort, stable and safe, with particular emphasis on stability and safety. In the vertical direction, two inverted U-shaped aluminum alloy tubes are selected as the pillars and handrails. In the horizontal direction, two layers of U-shaped aluminum alloy tubes are selected as the handrails and used to fix the columns.

Although the walker has made the above choices in terms of material and structure, because different elderly people have different physiques, abilities, and legs, the adaptability to the walker is not exactly the same. Generally speaking, the old people who can stand upright and walk alone can use this walker. For those old people who are poor in physique and can barely stand upright with the help of handrails, they can also use this walker to walk short distances on relatively flat ground. Walking on the road is enough for them. But for those old people who have better physical strength and better upright ability, they feel not enough, because the two columns behind the walker have no wheels, so it is not very convenient to walk on the ground at a normal speed, I even feel that the walker is a bit of a drag, especially when the ground is not smooth, and it is even more difficult when going uphill and downhill. I can only walk by lifting the walker with both hands.

In response to this situation, in one novel aspect, a four-wheel walker having front and rear wheels with different sizes are designed. The walker has two horizontally separated front supports 211 and two horizontally separated rear supports 212. The U shaped metal material forms two front legs/supports 211 and two rear legs/supports 212. One or more front connecting bars 310, while the dotted lined 310 are optional. One or more side connecting bars 410, while the dotted lined 410 are optional. FIG. 1 also illustrates a folding position 311 at bars 310. In one embodiment, as shown in FIG. 1, the two front wheels 101 are fixed wheels, each with a radius of R1. The two rear wheels 102 are swivel wheels, each with a radius of R2. While the traditional walker tends to only the front two wheels and the rear legs are directly ground engaging, many with rubber surfaces. The traditional design without the rear wheels is in consideration for stable concerns. However, it is hard to move the walker in a little rough ground. The current four-wheel walkers, however, have the same sized four wheels will cause the walker not as stable. To solve this problem, the current four-wheel walker uses hand brakes to solve the problem. In one embodiment, the R1 is greater than R2. In one embodiment, R1 is greater than or equal to three times of R2 (R1>=3*R2). In another embodiment, R1 is smaller than or equal to six times of R2 (R1<=6*R2).

In our current invention, a good balance of stability and easy to operate is provided. The smaller sized rear wheels provide much better stability than the same sized wheels. The smaller the rear wheels, the more stability it offers.

When the two front large wheels are fixed, and the two rear swivel wheels are much smaller, the four-wheel structure provides large stability. This is because the large front wheels provide a large amount of inertia, which resists changes in motion. The small rear wheels are able to swivel freely, which allows the vehicle to turn easily. The combination of these two features makes the four-wheel structure very stable. The large front wheels provide a large amount of inertia, which resists changes in motion. This means that it takes more force to accelerate or decelerate the vehicle. This helps to keep the vehicle stable, as it is less likely to change direction suddenly. The small rear wheels are able to swivel freely, which allows the vehicle to turn easily. This is important for stability, as it allows the vehicle to adjust its course as needed. If the rear wheels were fixed, the vehicle would be more likely to skid when making turns. The combination of these two features makes the four-wheel structure very stable. The large front wheels provide inertia, which resists changes in motion. The small rear wheels are able to swivel freely, which allows the vehicle to turn easily. This combination makes it difficult for the vehicle to lose control.

In another novel aspect, the two rear wheels are removable and changeable. For example, a pair of castors can be installed/attached to the end of the two rear legs and different sized rear wheels can be mounted. In one embodiment, a pair of fixed wheels are attached to each end of the two front legs, providing more stability. In yet another embodiment, the walker is foldable.

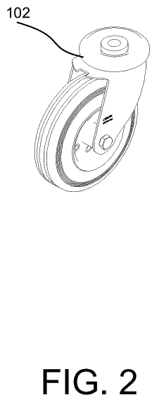

FIG. 2 illustrates an exemplary diagram of a swivel wheel for the rear wheel in accordance with embodiments of the current invention. As shown in FIG. 2, the two rear wheels are swivel wheels that offer flexibility to the walker.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed:

1. A walker with two large front wheels and two small rear wheels, comprising:
two laterally spaced front supports and two laterally spaced rear supports;
two ground engaging front wheels, each attached to each end of the two front supports;
two ground engaging rear wheels, each attached to each end the two rear supports, wherein the two ground engaging front wheels having an equal radius of R1, the two ground engaging rear wheels having an equal radius of R2, and wherein R1 is greater than R2.

2. The walker of claim 1, wherein the two front wheels are fixed wheels and the two rear wheels are swivel wheels.

3. The walker of claim 1, wherein R1 is greater than or equal to 3*R2.

4. The walker of claim 1, wherein R1 is smaller than or equal to 6*R2.

5. The walker of claim 1, wherein the walker is foldable.

6. The walker of claim 1, wherein the two rear wheels are removable.
